(19) United States
(12) Patent Application Publication
(10) Pub. No.: US 2008/0293865 A1
(43) Pub. Date: Nov. 27, 2008

(54) ROOM TEMPERATURE-CURABLE ORGANOPOLYSILOXANE COMPOSITION

(76) Inventors: Norio KAMEDA, Annaka-shi (JP); Tsuneo Kimura, Annaka-shi (JP)

Correspondence Address: BIRCH STEWART KOLASCH & BIRCH, PO BOX 747, FALLS CHURCH, VA, 22040-0747, US

(21) Appl. No.: 12/123,042

(22) Filed: May 19, 2008

(30) Foreign Application Priority Data
May 25, 2007 (JP) 2007-139318

(51) Int. Cl. C08L 83/05; C08K 3/26; C08K 3/36

(52) U.S. Cl. 524/425; 524/588; 525/478

(57) ABSTRACT

An RTV organopolysiloxane composition comprises (A) an organosiloxane polymer comprising R₃SiO_{1/2} units and SiO_{4/2} units in a molar ratio of 0.6-1.2 and having a hydroxysilyl content of 0.04-0.07 mole/100 g, (B) a polysiloxane having a hydrolyzable silyl group incorporated in the molecular chain via an alkylene linkage, (C) a hydrolyzable silane or its partially hydrolytic condensate having a boiling point of at least 150° C./101325 Pa, and (D) a cure catalyst. The composition remains stable during long-term storage. It has a low viscosity and good workability when heated, develops initial adhesion when allowed to cool after application, and thereafter cures at room temperature.

### CROSS-REFERENCE TO RELATED APPLICATION

This non-provisional application claims priority under 35 U.S.C. §119(a) on Patent Application No. 2007-139318 filed in Japan on May 25, 2007, the entire contents of which are hereby incorporated by reference.

### TECHNICAL FIELD

This invention relates to room temperature-curable organopolysiloxane compositions which have a low viscosity and good workability when heated, which develop initial adhesion when allowed to cool after application, and thereafter cure at room temperature and induce crosslinking reaction, affording improved rubber physical properties, and which have long-term shelf stability, so that they are suited for use as silicone-based sealing agents, adhesives, coating agents, potting agents or the like. It is noted that the term “room temperature-curable” is sometimes referred to as RTV as it is synonymous with room temperature-vulcanizable.

### BACKGROUND ART

One-part silicone compositions of the condensation cure type are used as sealing agents, adhesives, coating agents or potting agents in a wide variety of areas including buildings, electric and electronic equipment and components, transporting vehicles, electric appliances and the like. Since air-borne moisture is necessary for crosslinking reaction to take place, rubber gradually forms from the surface. This suggests that it takes several days until the composition cures to depth. It is thus very difficult to acquire an adhesion strength immediately after application. Green strength can be increased by heavily loading a silicone composition with fumed silica to provide an extremely increased viscosity. This improvement is made at the sacrifice of working efficiency.

Also used as sealing agents, adhesives, coating agents or potting agents are two-part silicone compositions of the condensation cure type in which a crosslinking agent is provided as a separate package. As compared with the one-part compositions, the two-part compositions are improved in deep cure. JP-A 7-118531 discloses that the combined use of an amine compound and a ketone compound enhances the deep cure. This composition still requires several days until satisfactory bond strength is developed.

One known measure of providing initial adhesion is U.S. Pat. No. 5,905,123 or Japanese Patent No. 3,642,584 that discloses a composition comprising a solid hydroxy-functional organopolysiloxane resin comprising R₃SiO_{1/2} units and SiO_{4/2} units, a terminally reactive organosiloxane polymer, a hydrolyzable silane, and a cure catalyst. This hot-melt silicone composition exhibits good initial adhesion. However, because the siloxane resin contains a large amount of hydroxysilyl groups, the composition must be loaded with a large amount of curing agent so that long-term storage is ensured. Then, the rubber after moisture curing suffers a decline of flexibility.

US 2006/0258817 or JP-A 2006-316190, assigned to the same assignee as the present invention, discloses a composition comprising a solid hydroxy-functional organopolysiloxane resin with a low hydroxysilyl content. The composition is good in long-term storage due to the low hydroxysilyl content in the siloxane resin, but the rubber after moisture curing is soft.

### DISCLOSURE OF THE INVENTION

An object of the present invention is to provide room temperature-curable organopolysiloxane compositions which have a low viscosity and good workability when heated, develop initial adhesion when allowed to cool after application, and thereafter cure at room temperature and induce crosslinking reaction, affording improved rubber physical properties, and have long-term shelf stability, so that they are suited for use as silicone-based sealing agents, adhesives, coating agents, potting agents or the like.

Making investigations with a focus on the viscosity versus temperature of a solid hydroxy-functional siloxane resin comprising R₃SiO_{1/2} units and SiO_{4/2} units, the inventor has found that a combination of a siloxane resin comprising R₃SiO_{1/2} units and SiO_{4/2} units and having a controlled content of hydroxysilyl groups in the molecule with a polysiloxane having a hydrolyzable silyl group incorporated in the molecular chain via an alkylene linkage and a hydrolyzable silane and/or siloxane establishes both workability when heated and adhesion when cooled. Further addition of a cure catalyst to the composition ensures improved rubber physical properties. As a result, there is obtained an RTV organopolysiloxane composition that satisfies these properties and has long-term storage stability.

The present invention provides a room temperature-curable organopolysiloxane composition comprising

(A) 100 parts by weight of an organosiloxane polymer comprising R₃SiO_{1/2} units and SiO_{4/2} units wherein R is each independently a substituted or unsubstituted monovalent hydrocarbon group of 1 to 6 carbon atoms, in a molar ratio of R₃SiO_{1/2} units to SiO_{4/2} units between 0.6/1 and 1.2/1, and containing 0.04 to 0.07 mole of hydroxysilyl groups per 100 g of the polymer,

(B) 50 to 200 parts by weight of a polysiloxane having a hydrolyzable silyl group incorporated in the molecular chain via an alkylene linkage,

(C) 0.1 to 30 parts by weight of a hydrolyzable silane and/or its partially hydrolytic condensate having a boiling point of at least 150° C./101325 Pa, and

(D) 0.01 to 10 parts by weight of a cure catalyst.

In a preferred embodiment, component (B) comprises at least one member selected from polysiloxanes having the general formulae (1) to (3):

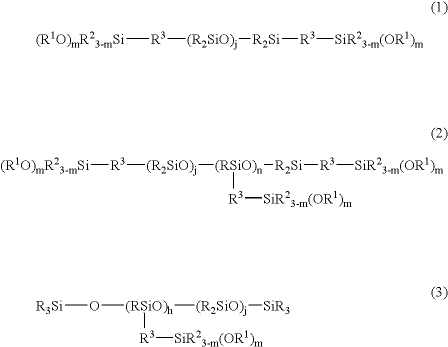

wherein R is as defined above, R¹ is each independently an alkyl group of 1 to 6 carbon atoms or alkoxyalkyl group of 2 to 10 carbon atoms, R² is each independently a substituted or unsubstituted monovalent hydrocarbon group, R³ is an alkylene group of 1 to 12 carbon atoms, m is an integer of 1 to 3, n is an integer of at least 1, j is an integer of at least 10, and h is an integer of at least 2.

In another preferred embodiment, a hydrolyzable silane having the following general formula (4):

R⁴₄₋ₚSi(OR⁵)ₚ (4)

wherein R⁴ is independently a substituted or unsubstituted monovalent hydrocarbon group of 1 to 18 carbon atoms, R⁵ is each independently an alkyl group of 1 to 6 carbon atoms or alkoxyalkyl group of 2 to 10 carbon atoms, and p is an integer of 2 to 4, or its partially hydrolytic condensate is preferably used as component (C) in an amount of 0.1 to 10 parts by weight per 100 parts by weight of component (A).

Moreover, in addition to the hydrolyzable silane of formula (4) or its partially hydrolytic condensate, a silane coupling agent is incorporated as component (C) in an amount of 0.1 to 20 parts by weight per 100 parts by weight of component (A).

In further preferred embodiment, the composition may further comprise:

(E) 1 to 500 parts by weight of a filler which is typically selected from fumed silica, precipitated silica and calcium carbonate.

The composition is best suited for use as a sealing agent, adhesive, coating agent or potting agent.

### BENEFITS OF THE INVENTION

The RTV organopolysiloxane compositions of the invention have a low viscosity and good workability when heated. They develop initial adhesion when allowed to cool after application, and thereafter cure at room temperature and induce crosslinking reaction, affording improved rubber physical properties. They are also improved in long-term storage stability.

### DESCRIPTION OF THE PREFERRED EMBODIMENT

### Component A

Component (A) in the RTV organopolysiloxane composition of the invention is an organosiloxane polymer comprising R₃SiO_{1/2} units and SiO_{4/2} units wherein R is each independently a substituted or unsubstituted monovalent hydrocarbon group of 1 to 6 carbon atoms. A molar ratio of R₃SiO_{1/2} units to SiO_{4/2} units ranges from 0.6:1 to 1.2:1. The polymer contains 0.04 to 0.07 mole of hydroxysilyl groups per 100 grams of the polymer. It is a resinous organosiloxane copolymer.

Specifically, R is independently at each occurrence selected from monovalent hydrocarbon groups of 1 to 6 carbon atoms, for example, alkyl groups such as methyl, ethyl, propyl, isopropyl, and hexyl; cycloalkyl groups such as cyclohexyl; alkenyl groups such as Vinyl, allyl and propenyl; aryl groups such as phenyl; and substituted monovalent hydrocarbon groups, for example, substituted forms of the foregoing groups in which some or all hydrogen atoms are substituted by halogen atoms or the like, such as chloromethyl and 3,3,3-trifluoropropyl. These copolymers can be prepared through co-hydrolytic condensation of a hydrolyzable triorganosilane and an R-free hydrolyzable silane or siloxane and are well known in the art.

A molar ratio of R₃SiO_{1/2} units to SiO_{4/2} units is in the range between 0.6:1 and 1.2:1 and preferably between 0.7:1 and 1.0:1. If the molar ratio is less than 0.6, the rubber after curing loses flexibility and has poor physical properties. If the molar ratio is in excess of 1.2, the initial adhesion is poor.

The organosiloxane polymer may further contain RSiO_{3/2} and R₂SiO_{2/2} units in a total amount of less than or equal to 10 mol %, preferably less than or equal to 5 mol % based on the total amount of R₃SiO_{1/2} and SiO_{4/2} units insofar as this does not compromise the benefits of the organosiloxane polymer.

The content of hydroxysilyl groups is 0.04 to 0.07 mole per 100 grams of the polymer. If the hydroxysilyl content is less than 0.04 mole/100 g, the rubber after curing has poor physical properties. If the hydroxysilyl content is more than 0.07 mole/100 g, the composition is unstable during storage.

### Component B

Component (B) is a polysiloxane having a hydrolyzable silyl group incorporated in the molecular chain via an alkylene linkage. It functions to improve the workability of the composition and provide the rubber with flexibility. Preferred as component (B) is one or more polysiloxanes having the general formulae (1) to (3).

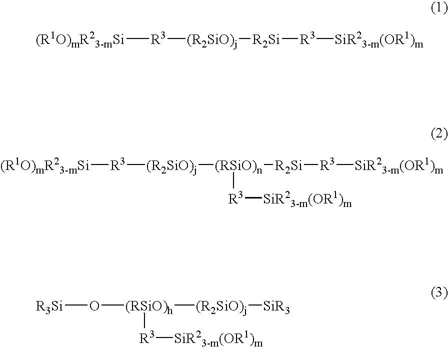

Herein R is as defined above. R¹ may be the same or different and stands for an alkyl group of 1 to 6 carbon atoms or an alkoxyalkyl group of 2 to 10 carbon atoms, preferably 2 to 6 carbon atoms. Exemplary alkyl groups include methyl, ethyl, propyl, isopropyl, and hexyl; and exemplary alkoxyalkyl groups include methoxymethyl, methoxyethyl, ethoxymethyl and ethoxyethyl. R² may be the same or different and is selected from substituted or unsubstituted monovalent hydrocarbon groups, which include alkyl groups of 1 to 20 carbon atoms, preferably 1 to 12 carbon atoms, aryl groups of 6 to 20 carbon atoms, preferably 6 to 15 carbon atoms, and substituted forms of the foregoing in which some hydrogen atoms are substituted by halogen atoms. Examples of R² include methyl, ethyl, propyl, isopropyl, butyl, hexyl, octyl, nonyl, myristyl, stearyl, phenyl, tolyl, xylyl, naphthyl, chloromethyl, and 3,3,3-trifluoropropyl. R³ is an alkylene group of 1 to 12 carbon atoms, preferably 2 to 4 carbon atoms, such as methylene, ethylene, trimethylene or tetramethylene. The subscript m is an integer of 1 to 3; n is an integer of at least 1, preferably in the range of 1 to 50, more preferably 1 to 20; j is an integer of at least 10, preferably in the range of 20 to 10,000, more preferably 50 to 2,000; and h is an integer of at least 2, preferably in the range of 2 to 50, more preferably 2 to 20.

The polysiloxane (B) should preferably have a viscosity in the range of 100 to 1,000,000 mPa-s, and more preferably in the range of 500 to 200,000 mPa-s, as measured at 25° C. by a rotational viscometer.

The polysiloxane (B) may be readily obtained through addition reaction of a silane having hydrosilyl and alkoxy groups to a corresponding alkenylsiloxane or of a silane having alkenyl and alkoxy groups to a corresponding hydrosiloxane, in the presence of a catalyst. Since the invention requires that the composition be heated prior to curing, the composition must be fully heat resistant in the uncured state. It is then requisite that the hydrolyzable silyl group be attached to the siloxane molecular chain via an alkylene linkage.

The polysiloxane is compounded in an amount of 50 to 200 parts by weight, preferably 70 to 150 parts by weight per 100 parts by weight of component (A). On this basis, less than 50 parts by weight of the polysiloxane provides the composition with a remarkably increased viscosity, detracting from workability when heated whereas more than 200 parts by weight fails to achieve satisfactory viscosity vs. temperature and rubber physical properties.

### Component C

Component (C) is a hydrolyzable silane or its partially hydrolytic condensate which serves as a shelf stabilizer and crosslinker in the composition. Since the invention requires that the composition be heated prior to curing, it is essential for the purpose of preventing bubbling or foaming that the hydrolyzable silane or siloxane have a boiling point of at least 150° C./101325 Pa. If a silane or its condensate having a boiling point of lower than 150° C./101325 Pa is used, a problem arises in that when the composition is heated at about 150° C. prior to extrusion, this compound volatilizes to form bubbles in the composition.

Preferably, component (C) is a hydrolyzable silane having the following general formula (4) or its partially hydrolytic condensate:

R⁴₄₋ₚSi(OR⁵)ₚ (4)

In formula (4), R⁴ is independently a substituted or unsubstituted monovalent hydrocarbon group of preferably 1 to 18 carbon atoms and more preferably 1 to 6 carbon atoms. Examples include an alkyl group such as methyl, ethyl, propyl, butyl, pentyl, hexyl, heptyl, octyl, nonyl, decyl and octadecyl; an alkenyl group such as vinyl and allyl; an aryl group such as phenyl, tolyl and xylyl; an aralkyl group such as benzyl, phenethyl and phenylpropyl, and; a substituted group in which at least one hydrogen atom of the above unsubstituted monovalent hydrocarbon group is replaced by a halogen atom or cyano group (e.g., a halogenated alkyl group such as 3-chloropropyl and 3,3,3-trifluoropropyl). R⁵ may be the same or different and stands for an alkyl group of 1 to 6 carbon atoms or an alkoxyalkyl group of 2 to 10 carbon atoms, preferably 2 to 6 carbon atoms, as in R¹ described above.

The partially hydrolytic condensate is a siloxane oligomer containing a hydrolyzable group (preferably, alkoxy group). The siloxane oligomer usually is a siloxane having a degree of polymerization of 2 to 9, and preferably a mixture composed of at least 50% by weight, especially at least 70% by weight of oligomers having a degree of polymerization of 2 to 4, up to 30% by weight, especially up to 20% by weight, and up to 20% by weight, especially up to 10% by weight of oligomers having a degree of polymerization of 6 to 9. The oligomer having a degree of polymerization of 5 to 9 may be 0% by weight.

Examples of suitable hydrolyzable silanes of formula (4) and the siloxane oligomers include

phenyltrimethoxysilane (b.p. 110° C./2666 Pa, 230° C./101325 Pa),
α-trimethoxysilyldecane (b.p. 132° C./1333 Pa, 280° C./101325 Pa),
methyltriethoxysilane (b.p. 161° C./101325 Pa),
vinyltriethoxysilane (b.p. 63° C./2666 Pa, 167° C./101325 Pa),
phenyltriethoxysilane (b.p. 116° C./1867 Pa, 246° C./101325 Pa),
tetraethoxysilane (b.p. 80° C./5333 Pa, 170° C./101325 Pa),
methyltriisopropoxysilane (b.p. 82° C./1733 Pa, 204° C./101325 Pa),
partial hydrolyzates of tetramethoxysilane (b.p. at least 170° C./101325 Pa),
partial hydrolyzates of tetraethoxysilane (b.p. at least 200° C./101325 Pa),
partial hydrolyzates of methyltrimethoxysilane (b.p. at least 60° C./1333 Pa, at least 180° C./101325 Pa), and
phenyltriisopropenoxysilane (b.p. 118° C./676 Pa, 250° C./101325 Pa).

A silane coupling agent having a boiling point of at least 150° C./101325 Pa may be incorporated as component (C). In this case, it is preferred that the silane coupling agent is used in combination with the hydrolyzable silane or its partially hydrolytic condensate.

The silane coupling agent functions as an adhesion promoter. The known silane coupling agent in the art may be used preferred are those silane coupling agents having an alkoxysilyl or alkenoxysilyl group as the hydrolyzable group, including

vinyltris(β-methoxyethoxy)silane (285° C./101325 Pa).
γ-methacryloxypropyltrimethoxysilane (b.p. 255° C./101325 Pa),
β-(3,4-epoxycyclohexyl)ethyltrimethoxysilane (b.p. 310° C./101325 Pa),
γ-glycidoxypropyltrimethoxysilane (b.p. 290° C./101325 Pa),
γ-glycidoxypropylmethyldiethoxysilane (b.p. 259° C./101325 Pa),
N-(β-aminoethyl)-γ-aminopropyltrimethoxysilane (b.p. 259° C./101325 Pa),
γ-aminopropyltriethoxysilane (b.p. 217° C./101325 Pa),
γ-mercaptopropyltrimethoxysilane (b.p. 219° C./101325 Pa),
γ-glycidoxypropyltriisopropenoxysilane (b.p. 315° C./101325 Pa), and
γ-glycidoxypropylmethyldiisopropenoxysilane (b.p. 275° C./101325 Pa). Inter alia, amine-based, epoxy-based, mercapto-based, acryl-based and methacryl-based silane coupling agents are desirable. More preferably, amine-based and epoxy-based silane coupling agents are desirably used.

Component (C) is compounded in an amount of 0.1 to 30 parts by weight, and preferably 1 to 15 parts by weight per 100 parts by weight of component (A). If the amount of component (C) is too less, shelf stability is compromised and crosslinking reaction takes place to only an insufficient extent to provide rubber physical properties. If the amount of component (C) is too much, flexible rubber is not obtainable.

In this case, when the hydrolyzable silane of formula is (4) or its partially hydrolytic condensate is used as component (C), the amount thereof is preferably 0.1 to 10 parts by weight, especially 1 to 5 parts by weight of 100 parts by weight of component (A).

When the silane coupling agent is further added as component (A) in combination with the silane of formula (4) or its condensate, the silane coupling agent is used in an amount of 0.1 to 20 parts by weight, and preferably 0.2 to 10 parts by weight per 100 parts by weight of component (A). On this basis, less than 0.1 parts by weight of component (F) may fail to promote adhesion whereas more than 20 parts by weight is economically disadvantageous.

### Component D

Component (D) in the composition is a cure catalyst that catalyzes condensation reaction. Suitable cure catalysts include tin ester compounds such as tin dioctoate; alkyltin ester compounds such as dibutyltin diacetate, dibutyltin dilaurate, and dibutyltin dioctoate; titanates and titanium chelates such as tetraisopropoxytitanium, tetra-n-butoxytitanium, tetrakis(2-ethylhexoxy)titanium, dipropoxybis(acetylacetonato)titanium, and titanium isopropoxyoctylene glycol; organometallic compounds such as zinc naphthenate, zinc stearate, zinc 2-ethyloctoate, iron 2-ethylhexoate, cobalt 2-ethylhexoate, manganese 2-ethylhexoate, cobalt naphthenate, and alkoxyaluminum compounds; aminoalkyl-substituted alkoxysilanes such as 3-aminopropyltriethoxysilane and

N-(β-aminoethyl)-γ-aminopropyltrimethoxysilane; amine compounds and salts thereof such as hexylamine, dodecylamine phosphate, tetramethylguanidine and diazabicyclononane; quaternary ammonium salts such as benzyltriethylammonium acetate; alkali metal salts of lower fatty acids such as potassium acetate, sodium acetate and lithium oxalate; dialkylhydroxylamines such as dimethylhydroxylamine and diethylhydroxylamine; and guanidyl-containing silanes or siloxanes such as tetramethylguanidylpropyltrimethoxysilane, tetramethylguanidylpropylmethyldimethoxysilane and tetramethylguanidylpropyltris(trimethylsiloxy)silane. Of these, preferred are the amine compounds such as tetramethylguanidine and diazabicyclononane, and the guanidyl-containing silanes or siloxanes such as tetramethylguanidylpropyltrimethoxysilane, tetramethylguanidylpropylmethyldimethoxysilane and tetramethylguanidylpropyltris(trimethylsiloxy)silane. The tin ester compounds and alkyltin ester compounds are also preferred. These catalysts may be used alone or in admixture of two or more.

The cure catalyst is used in an amount of 0.01 to 10 parts by weight, and preferably 0.05 to 5 parts by weight per 100 parts by weight of component (A). Outside the range, less amounts of the cure catalyst are ineffective for rubber formation whereas more amounts provide a fast cure rate to interfere with working.

### Component E

In the composition, (E) a filler may be compounded as a reinforcing or extending agent. Suitable fillers include surface treated and/or untreated fumed silica, wet silica, precipitated silica, metal oxides, metal hydroxides, metal carbonates, glass beads, glass balloons, resin beads, resin balloons, and the like. Fumed silica, precipitated silica and calcium carbonate are preferred.

Typically the filler (E) is used in an amount of 1 to 500 parts by weight, and preferably 5 to 250 parts by weight per 100 parts by weight of component (A). On this basis, less than 1 parts by weight of the filler may fail to achieve the reinforcing and extending effects whereas more than 500 parts by weight may cause difficulty in discharging the composition and detract from workability.

### Additives

Optionally, a variety of additives may be added to the composition insofar as they do not adversely affect the benefits of the invention. Suitable additives include thixotropic agents such as polyethers, plasticizers such as silicone oil and isoparaffins, colorants such as pigments, dyes and fluorescent brighteners, biologically active agents such as mildew-proof agents, antifungal agents, insect repellents and marine organism repellents, bleed oils such as phenylsilicone oil and fluorosilicone oil, surface modifiers such as silicone-incompatible organic liquids, and solvents such as toluene, xylene, gasoline, cyclohexane, methylcyclohexane, and low-boiling isoparaffins.

On use, the composition is heated to a temperature of 50 to 250° C., and especially 100 to 200° C. so as to reduce the viscosity thereof, coated or otherwise applied to substrates (e.g., metals, organic resins or the like), then allowed to cool to room temperature. During the cooling process, the composition develops adhesion. When held under the ambient condition for some time, the composition cures through condensation.

The inventive compositions are effectively workable and adherent during the process and once cured, show satisfactory rubber physical properties. In addition, they remain fully stable during long-term storage. They are best suited for use as sealing agents, adhesives, coating agents, potting agents or the like.

### EXAMPLE

Examples of the invention are given below by way of illustration and not by way of limitation. Note that all parts are by weight, and the viscosity is a measurement at 25° C. by a rotational viscometer. Me is methyl.

### Example 1

Composition #1 was prepared by combining 100 parts of an organosiloxane polymer consisting of Me₃SiO_{1/2} units and SiO_{4/2} units in a molar ratio of Me₃SiO_{1/2} units to SiO_{4/2} units of 0.75 and having a hydroxysilyl content of 0.055 mole/100 g, 100 parts of a dimethylpolysiloxane capped at both ends with a trimethoxysilyl group via a silethylene group and having a viscosity of 30,000 mPa-s, 3 parts of a partial hydrolyzate of methyltrimethoxysilane (b.p. at least 180° C./101325 Pa), and 1 part of dipropoxybis(acetylacetonato)titanium, and mixing them until uniform.

### Example 2

Composition #2 was prepared as in Example 1 except that 5 parts by weight of fumed silica (Aerosil R-972 available from Japan Aerosil K.K.) was further added to Composition #1 of Example 1.

### Example 3

Composition #3 was prepared as in Example 1 except that 3 parts by weight of 3-aminopropyltriethoxysilane was further added to Composition #1 of Example 1.

### Comparative Example 1

Composition #4 was prepared as in Example 1 except that an organosiloxane polymer consisting of Me₃SiO_{1/2} units and SiO_{4/2} units in a molar ratio of Me₃SiO_{1/2} units to SiO_{4/2} units of 0.75 and having a hydroxysilyl content of 0.025 mole/100 g was used instead of the organosiloxane polymer consisting of Me₃SiO_{1/2} units and SiO_{4/2} units in a molar ratio of Me₃SiO_{1/2} units to SiO_{4/2} units of 0.75 and having a hydroxysilyl content of 0.055 mole/100 g.

### Comparative Example 2

Composition #5 was prepared as in Example 1 except that an organosiloxane polymer consisting of Me₃SiO_{1/2} units and SiO_{4/2} units in a molar ratio of Me₃SiO_{1/2} units to SiO_{4/2} units of 0.75 and having a hydroxysilyl content of 0.15 mole/100 g was used instead of the organosiloxane polymer consisting of Me₃SiO_{1/2} units and SiO_{4/2} units in a molar ratio of Me₃SiO_{1/2} units to SiO_{4/2} units of 0.75 and having a hydroxysilyl content of 0.055 mole/100 g.

### Comparative Example 3

Composition #6 was prepared as in Example 1 except that methyltrimethoxysilane (b.p. 102° C./101325 Pa) was used instead of the partial hydrolyzate of methyltrimethoxysilane.

The compositions of Example 1 and Comparative Examples 1-3 were coated onto aluminum, glass, and polybutylene terephthalate (PBT) adherends in a 150° C. atmosphere and cooled to 23° C., after which adhesion was examined. Separately, the compositions were formed into sheets of 2 mm thick in a 150° C. atmosphere and allowed to cure in an atmosphere of 23±2° C. and 50±5% RH for 7 days, after which rubber physical properties were determined. Separately, the compositions were allowed to stand in a moisture-barrier atmosphere of 70° C. for 7 days, and the state of the compositions was observed for comparison with the initial state. The test methods are described below and the test results are shown in Table 1.

Adhesion

While the rubber coating after curing was pulled from the adherend surface at an angle of 0°, the adhesion was rated by visual observation. The rubber was rated as “peel” when it could be lightly peeled from the adherend, “adherent” when it was heavily peeled from the adherend, and “bonding” when it was not peeled from the adherend.

Rubber Physical Properties

Hardness (Durometer A scale), elongation and tensile strength were measured according to JIS K-6249.

Aged State

After the storage at 70° C. for 7 days, the composition was extruded in a 150° C. atmosphere. When the aged composition is inferior in ease of extrusion to the initial composition, this composition is labeled “gelled.”

TABLE 1

| | | Example | | | Comparative Example | | |
|---|---|---|---|---|---|---|---|
| | | 1 | 2 | 3 | 1 | 2 | 3 |
| Composition | | #1 | #2 | #3 | #4 | #5 | #6 |
| Adhesion | Aluminum | adherent | adherent | bonding | adherent | adherent | adherent |
| | Glass | adherent | adherent | bonding | adherent | adherent | adherent |
| | PBT | adherent | adherent | adherent | peel | adherent | adherent |
| Rubber physical | Hardness | 45 | 58 | 48 | 15 | 60 | 40 |
| properties | (Durometer A) | | | | | | |
| | Elongation | 750 | 900 | 700 | 800 | 1000 | 100 |
| | (%) | | | | | | |
| | Tensile | 5.5 | 6.0 | 5.0 | 2.0 | 5.5 | 0.9 |
| | strength (MPa) | | | | | | |
| Bubbles in sheet | | Nil | Nil | Nil | Nil | Nil | Found |
| Storage | 70° C. × 7 days | Unchanged | Unchanged | Unchanged | Unchanged | Gelled | Unchanged |
| stability | | | | | | | |

Japanese Patent Application No. 2007-139318 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A room temperature-curable organopolysiloxane composition comprising
(A) 100 parts by weight of an organosiloxane polymer comprising R₃SiO_{1/2} units and SiO_{4/2} units wherein R is each independently a substituted or unsubstituted monovalent hydrocarbon group of 1 to 6 carbon atoms, in a molar ratio of R₃SiO_{1/2} units to SiO_{4/2} units between 0.6/1 and 1.2/1, and containing 0.04 to 0.07 mole of hydroxysilyl groups per 100 g of the polymer,
(B) 50 to 200 parts by weight of a polysiloxane having a hydrolyzable silyl group incorporated in the molecular chain via an alkylene linkage,
(C) 0.1 to 30 parts by weight of a hydrolyzable silane and/or its partially hydrolytic condensate having a boiling point of at least 150° C./101325 Pa, and
(D) 0.01 to 10 parts by weight of a cure catalyst.

2. The composition of claim 1, wherein component (B) comprises at least one member selected from polysiloxanes having the general formulae (1) to (3): 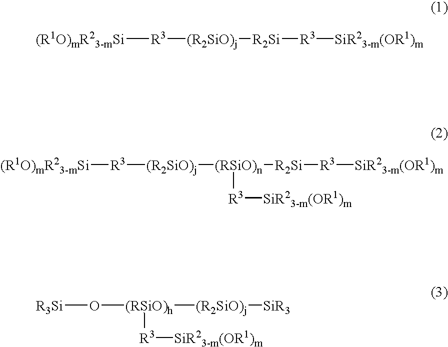
wherein R is as defined above, R¹ is each independently an alkyl group of 1 to 6 carbon atoms or alkoxyalkyl group of 2 to 10 carbon atoms, R² is each independently a substituted or unsubstituted monovalent hydrocarbon group, R³ is an alkylene group of 1 to 12 carbon atoms, m is an integer of 1 to 3, n is an integer of at least 1, j is an integer of at least 10, and h is an integer of at least 2.

3. The composition of claim 1, wherein a hydrolyzable silane having the following general formula (4):
R⁴₄₋ₚSi(OR⁵)ₚ (4)
wherein R⁴ is independently a substituted or unsubstituted monovalent hydrocarbon group of 1 to 18 carbon atoms, R⁵ is each independently an alkyl group of 1 to 6 carbon atoms or alkoxyalkyl group of 2 to 10 carbon atoms, and p is an integer of 2 to 4, or its partially hydrolytic condensate is preferably used as component (C) in an amount of 0.1 to 10 parts by weight per 100 parts by weight of component (A).

4. The composition of claim 3, wherein in addition to the hydrolyzable silane of formula (4) or its partially hydrolytic condensate, a silane coupling agent is incorporated as component (C) in an amount of 0.1 to 20 parts by weight per 100 parts by weight of component (A).

5. The composition of claim 1, further comprising (E) 1 to 500 parts by weight of a filler.

6. The composition of claim 3, wherein the filler is selected from fumed silica, precipitated silica and calcium carbonate.

7. The composition of claim 1, which is used as a sealing agent, adhesive, coating agent or potting agent.
